(19) United States
(12) Patent Application Publication
(10) Pub. No.: US 2017/0300926 A1
(43) Pub. Date: Oct. 19, 2017

(54) SYSTEM AND METHOD FOR SURVEYING DISPLAY UNITS IN A RETAIL STORE

(71) Applicant: Asda Stores Limited, Leeds Yorkshire (GB)

(72) Inventor: Philip Alexander STOUT, Atherton (GB)

(73) Assignee: Asda Stores Limited, Leeds Yorkshire (GB)

(21) Appl. No.: 15/512,542

(22) PCT Filed: Oct. 1, 2015
(86) PCT No.: PCT/GB2015/052874

§ 371 Date: Mar. 17, 2017

(30) Foreign Application Priority Data
Oct. 1, 2014 (GB) 1417361.1

(51) Int. Cl. G06Q 30/00; H04N 7/18; G06Q 30/02; G06F 17/30; G06K 9/62; G06K 9/20; G06K 9/34

(52) U.S. Cl. CPC G06Q 30/018; G06Q 30/0201; H04N 7/185; G06F 17/3028; G06K 9/209; G06K 9/344; G06K 9/6202

(57) ABSTRACT

A display unit survey system comprises a wearable device such as smart glasses configured to capture a plurality of survey images showing display units in a retail store and to generate survey image metadata associated therewith. At least one server device holds a survey image database to store the survey images and metadata, wherein the at least one server device is configured to determine a supplier entity for each survey image according to the survey image metadata, collate the stored survey images into a plurality of packages according to the determined supplier entity, and communicate each package to a recipient device of the determined supplier entity.

### CROSS REFERENCING OF RELATED APPLICATION

The present application claims priority to and is a national phase filing of PCT Application No. PCT/GB2015/052874, entitled “System and Method for Surveying Display Units in a Retail Store”, filed 1 Oct. 2015 in the receiving office of the United Kingdom. Further, the present application claims priority under the Paris Convention to application number 1417361.1, entitled “System and Method for Surveying Display Units in a Retail Store”, filed on 1 Oct. 2014 in United Kingdom.

### BACKGROUND OF THE INVENTION

### Technical Field

The present application relates in general to systems and methods for surveying display units, such as within a retail store or across a network of retail stores.

### Description of Related Art

Modern retail stores sell a wide variety of items, including foodstuffs, home and kitchen goods, electronic goods, clothing, sporting goods and so on. Typically, the items are displayed on display units with other similar goods. Often the display units are shelving units, though of course other forms of display unit are often employed. The items are removed from the display units by customers, and taken to a point of sale or checkout to be purchased, and the units are replenished with items by retail store staff on a periodic basis. Many of the items are either produced by or produced especially for the retailer themselves, and carry the retailer's own branding to indicate their origin. These goods are often referred to as “own-brand” goods.

In addition, retail stores carry many goods that are produced by and carry the branding of third party suppliers. Often, the agreement to supply the goods is predicated on the goods being displayed within the retail store in a particular way. Additionally, the third party supplier may arrange with the retail store in order to have their goods displayed in a particularly advantageous manner. For example, the goods may be displayed on a particular type of display unit, such as one which shows the branding of the supplier, or in a particular area of the store. If the goods are subject to a discounted or promotional price, there may be a requirement that the promotion is clearly displayed in a manner in accordance with the supplier's wishes.

Such stipulations are of great importance to the marketing strategy of the third party suppliers, because they increase the visibility of their branded goods. Consequently, the retailer and the suppliers go to considerable effort to ensure that the goods are displayed in the stipulated manner.

Particularly, the third party suppliers may employ numerous staff whose duties comprise travelling to retail stores on a regular basis to gather evidence of the correct display of the relevant branded goods. The gathering of evidence may comprise, for example, capturing photographs of the display and/or generating evidential documents which record the retail store's compliance with the stipulations in writing. Clearly, such measures for ensuring the goods are displayed in the stipulated fashion are both time consuming and expensive.

It is an aim of some examples to address at least some of the above difficulties, or other difficulties which will be appreciated from the description below. It is a further aim to provide convenient and cost effective systems and methods for surveying display units in a retail store.

### SUMMARY OF THE INVENTION

According to the present invention there is provided an apparatus and method as set forth in the appended claims. Other features of the invention will be apparent from the dependent claims, and the description which follows.

In one example there is described a display unit survey system which comprises a wearable device such as smart glasses configured to capture a plurality of survey images showing display units in a retail store and to generate survey image metadata associated therewith. At least one server device holds a survey image database to store the survey images and metadata, wherein the at least one server device is configured to determine a supplier entity for each survey image according to the survey image metadata, collate the stored survey images into a plurality of packages according to the determined supplier entity, and communicate each package to a recipient device of the determined supplier entity.

In one example there is described a display unit survey system, comprising: a wearable device configured to be worn by a user while in use, wherein the wearable device is configured to capture a plurality of survey images showing display units in a retail store and to generate survey image metadata associated therewith, and at least one server device coupled to the wearable device by a communication network, the server device comprising a survey image database configured to store the survey images and the survey image metadata associated with the survey images, wherein the at least one server device is configured to determine a supplier entity for each survey image according to the survey image metadata, collate the stored survey images into a plurality of packages according to the determined supplier entity, and communicate each package to a recipient device of the determined supplier entity.

In one example, the at least one server device holds a supplier database and is configured to determine the supplier entity for each survey image according to the survey image metadata using the supplier database.

In one example, the survey image metadata relates the survey image to a respective display unit and wherein the supplier database relates display units to supplier entities.

In one example, the survey image metadata relates the survey image to a respective product on a display unit and wherein the supplier database relates product data to supplier entities.

In one example, the at least one server device comprises a grouping unit configured to collate the survey images stored in the survey image database into one or more supplier groups, wherein each supplier group comprises survey images which show the products of one respective supplier entity.

In one example, the grouping unit is configured to group each supplier group into one or more further subgroups including retail store location sub-groups, display unit sub-groups and/or product sub-groups.

In one example, the at least one server device comprises a packing unit configured to pack the collated survey images into the package for communication to a recipient device of a respective supplier entity.

In one example, the packing unit is configured to provide a hierarchical folder structure within the package.

In one example, the package comprises an archive file.

In one example, the package further comprises a survey report describing the survey images provided in the package.

In one example, the at least one server device comprises a controlling server linked by a communication network to a plurality of local servers each operating in a respective retail store location and communicatively coupled to one or more wearable device in the respective retail store location.

In one example, the controlling server is arranged to collate a plurality of the survey images that have been captured at each of a plurality of retail store locations together into one package and to communicate the one package to the recipient device of the determined supplier entity.

In one example, a plurality of said wearable devices are configured to capture the survey images and obtain the survey image metadata associated with each survey image based on a current location of the wearable device, and wherein the at least one server is configured to collate a plurality of the survey images received from the plurality of wearable devices together into one package for each determined supplier entity.

In one example, the wearable device is configured to operate in a scanning mode, in which the wearable device automatically and repeatedly captures the survey images without additional user inputs.

In one example, the wearable device is a pair of smart glasses.

In one example there is described a method of surveying display units in retail stores, the method comprising: capturing a plurality of survey images showing the display units; generating survey image metadata associated with each said survey image, respectively; storing the captured survey images and generated survey image metadata in a survey image database; determining a supplier entity relevant to each captured survey images in the survey image database based on the survey image metadata; collating the stored survey images into a plurality of packages according to the determined supplier entity for each image, and communicating each package across a computer network to at least one relevant recipient device of the determined supplier entity.

In one example there is provided a wearable device which is configured to operate as described herein.

In one example there is provided a server device which is configured to operate as described herein. The server device may be a local server or a controlling server, as described herein.

In one example there is provided a computer readable medium having instructions recorded thereon which when executed cause a computer device to perform any of the methods described herein.

### BRIEF DESCRIPTION OF THE DRAWINGS

For a better understanding of the invention, and to show how example embodiments may be carried into effect, reference will now be made to the accompanying drawings in which:

FIG. 1 is a schematic view of a retail store in which an example system may operate;

FIG. 2 is a schematic view of an example system;

FIG. 3 is a flowchart of an example method of monitoring display unit compliance;

FIG. 4 is an exemplary display of a wearable device of the system;

FIG. 5 is a flowchart of a further exemplary method;

FIG. 6 is a schematic view of a further exemplary system;

FIG. 7 is a flowchart of a further exemplary method;

FIG. 8 is a schematic view of an exemplary display unit surveying system;

FIG. 9 is a schematic view of an exemplary system in use; and

FIG. 10 is a flowchart of a method of surveying display units in a retail store.

In the drawings, corresponding reference characters indicate corresponding components. The skilled person will appreciate that elements in the figures are illustrated for simplicity and clarity and have not necessarily been drawn to scale. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

### DETAILED DESCRIPTION OF EXAMPLE EMBODIMENTS

At least some of the following exemplary embodiments provide an improved system and method suitable for monitoring display units in a retail store. Many other advantages and improvements will be discussed in more detail below, or will be appreciated by the skilled person from carrying out exemplary embodiments based on the teachings herein. The exemplary embodiments have been described particularly in relation to a retail store such as a supermarket or general store for grocery and household items. However, it will be appreciated that the example embodiments may be applied in many other specific environments.

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

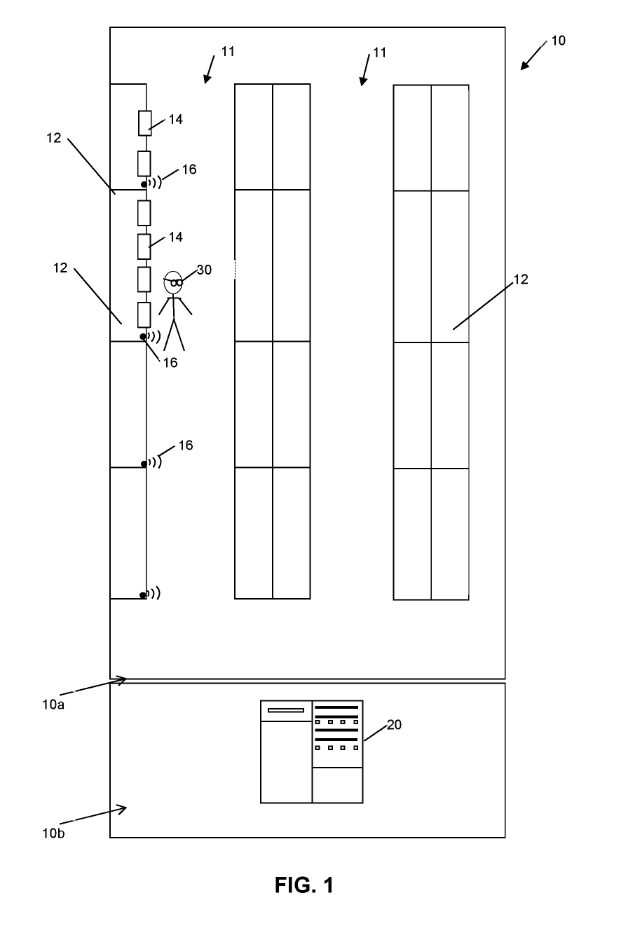

FIG. 1 shows a schematic view of a physical environment in which an exemplary embodiment of the system may operate. The physical environment may comprise a retail store 10. The retail store 10 typically comprises a sales area 10a, in which goods are displayed, and an operational area 10b, in which further stock may be held, and infrastructure for the maintenance of the sales area is installed. The operational area 10b may include a server 20, which will be described in further detail below. The retailer's computer network in practice may have many hundreds of stores with various local servers linked to one or more central control computers operated by the retailer, e.g. in their head office. These central control servers may in turn communicate across suitable communication networks with computer systems of suppliers and manufacturers.

The sales area 10a typically includes a plurality of aisles 11, wherein each aisle further comprises a plurality of display units 12. In one example, a display unit 12 may further be comprised of a plurality of shelves (not shown). The display unit 12 may include one or more product labels 14 arranged to be prominently visible to a customer. In one example, the product labels 14 are shelf edge labels as will be familiar to those skilled in the art. The product label 14 may be a printed label. The label 14 may be printed with ink on a substrate such as paper.

Each display unit 12 displays one or more product items. For example, a display unit 12 might display bottles of soft drink A, bottles of soft drink B and cans of soft drink C, amongst other items.

The configuration of the retail store 10 is a matter of some importance, because the layout of the aisles 11 and configuration of the display units 12 has the potential to both positively and negatively impact on sales. Particularly, the layout of the items on the display units 12 is often carefully planned by staff who are trained to maximise the visual appeal of such units 12. However, it will be understood that many configurations of retail store layout and display unit layout are possible, and the embodiments described below are not dependent upon any particular layout or configuration.

FIG. 1 also shows a wearable device 30 which will be described in further detail below. The wearable device 30 is suitable to be worn by a user. In the example embodiments, the user or operator is a member of staff of the retail store.

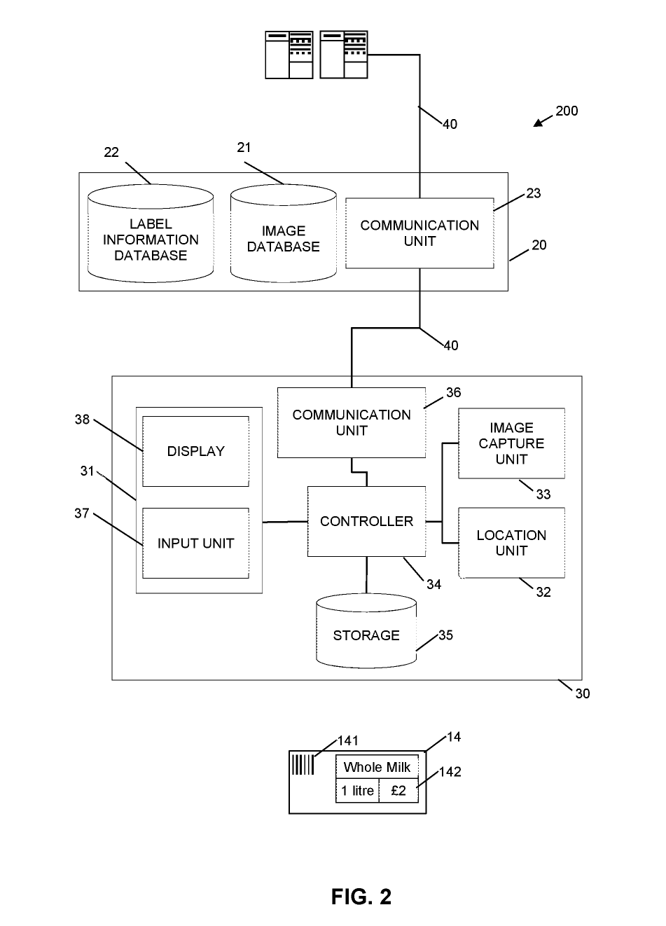

FIG. 2 shows a schematic diagram of a display unit compliance system 200.

In one example, the system 200 comprises at least one wearable device 30, and at least one server 20 which holds a label information database 22. Conveniently, the label information database 22 stores label information related to the items which are offered for sale in the retail store 10. The label information may comprise information which is displayed on the product labels 14. Particularly, the label information may comprise a description, a quantity, a price, and other data relevant to the items. In one example, the label information may further comprise information regarding any promotional offers (e.g. “buy one get one free”, “three for the price of two”, “20% extra free”), and information relating to the size of the items (e.g. “6×330 ml”, “454 g”). The label information database 22 may be updated on a periodic basis, or updated dynamically to reflect changes in the prices of items in the retail store.

In one example, the server 20 and the wearable device 30 may be linked by a communication network 40. The network may take any suitable form, including secure wired and/or wireless communication links, as will be familiar to those skilled in the art. In one exemplary embodiment, the server 20 may be located within the retail store 10, and may be connected to the wearable device 30 using a wireless local area network (e.g. a WiFi network). In further exemplary embodiments, the server 20 may be located off-site, either in a central or regional data processing site operated by the retailer or some other remote location, and the connection between server 20 and wearable device 30 may include a wide area network, such as over a private leased line or the Internet.

The server 20 may further include a communication unit 23, which is operable to manage communications over the network 40 between the server 20 and the wearable device 30. The server communication unit 23 may also manage communication between the server 20 and other servers. Thus, the server 20 may be part of a corporate server network or back-end network. For example, these other servers may be located in other stores, in other regional data processing sites or in a head office site. In one embodiment, information for updating data held at the server 20, such as the label information database 22, may be received from a controlling server at the head office site, via the server communication unit 23.

Conveniently, the label information database 22 is held on the server 20 to be accessible in use by the wearable device 30. However, it will be understood by those skilled in the art that the label information database 22 could instead be stored locally on the wearable device 30, e.g. by caching part or all of the stored information. Further, some or all of the database may be made available via any other suitable computing device as a distributed database.

Portable devices, such as tablets or smart phones, are well known. Such devices are designed and intended to be carried by a user, and are configured to be operated while in the hands of the user. By contrast, the wearable device 30 is also portable, but is further designed to be worn by a user during operation of the device. Advantageously, a wearable device may be configured to leave the user's hands free to perform other tasks while operating the device. The wearable device 30 may be smart glasses such as Google Glass™. In other examples, the wearable device 30 may be configured as a pendant, a smart watch, or a hat. In yet further examples, the wearable device 30 may be constructed as a patch or as a thin film incorporated in or attached to clothing, or any other piece of clothing or accessory which is adapted to incorporate technological elements.

In one example, the wearable device 30 may comprise a controller 34, a storage 35, a user interface (UI) module 31, a communication unit 36, a location unit 32 and an image capture unit 33. The user interface module 31 may include an input unit 37 and a display 38.

The controller 34 is operable to control the wearable device 30, and may take the form of a processor. The storage 35 is operable to store, either transiently or permanently, any relevant data required for the operation and control of the wearable device 30. The communication unit 36 is operable to manage communications with the server 20 over any suitable network.

The user interface module 31 is operable to input and output information to a user via one or more interfaces. In one exemplary embodiment the UI module 31 comprises an input unit 37 which is operable to receive instructions or commands from the user, and a display 38, which is operable to display at least one image to the user.

The display 38 may be a screen which is integral to the wearable device 30, but it is not limited thereto. In an embodiment where the wearable device 30 is a pair of smart glasses, the display 38 may be a Heads-Up Display (HUD) on the glass or a similar display projected into the field of view of the user.

The input unit 37 may receive user input by means of a button, a touch-screen unit, voice activation, gesture recognition or any other suitable means for receiving user instructions. The input unit 37 may also be operable to receive user input from a combination of these sources

The image capture unit 33 comprises a camera and is operable to capture an image.

The wearable device 30 may further comprise a location unit 32. The location unit 32 may be operable to detect the location of the wearable device 30. The location unit 32 may determine a current position of the device 30 within the retail store 10, such as by using an indoor positioning system. The indoor positioning system may employ the Global Positioning System (GPS) to establish the location of the device 30 within the retail store. The location unit 32 may instead or in addition employ proximity sensors using Bluetooth® low energy (e.g. iBeacons), WiFi, Near-Field Communication (NFC) or any other suitable locating means.

In one example, the display units 12 are adapted to contain locator beacons 16 as shown in FIG. 1, such as Bluetooth low energy beacons (e.g. iBeacons). The wearable device 30 may determine location using one or more of the locator beacons 16 (e.g. based on relative signal strength, or based on each beacon covering a certain floor area).

In one example, the locator beacons 16 may also act as a source of relevant information, which may be transmitted locally over the Bluetooth or other wireless connection to the wearable device 30. For example, a locator beacon unit is loaded with information relevant to the display unit 12 associated with that beacon. The locator beacon unit may now act as an intermediary on behalf of the server 20. The locator beacon unit may transmit the stored information relevant to the associated display unit 12 when the wearable device 30 is in the proximity of that locator beacon unit.

In a further exemplary embodiment, the location unit 32 may be configured to scan a visible machine-readable code, such as a barcode attached to a display unit 12, to establish the current position of the wearable device 30.

In one example, the code may be displayed on a shelf edge label. In further exemplary embodiments, the code may be a barcode attached to an item displayed on the display unit 12, and the location unit 32 may establish the current position of the device 30 based on the expected location of that item in a store layout plan.

FIG. 2 shows an exemplary product label 14 in the form of a shelf edge label. The product label 14 comprises at least one machine readable portion 141, such as a barcode. The product label 14 suitably further comprises at least one human readable portion 142 giving metadata in relation to the product, such as the manufacturer, description, quantity, price, and so on.

In use, the wearable device 30 controls the image capture unit 33 to capture an image of the product identification information displayed on the product label 14. The identification information may comprise a barcode or any other suitable machine-readable information, which relates to an item displayed on the display unit 12.

The wearable device 30 may capture the image in response to a user command received via the input unit 37 (e.g. a spoken command such as “OK Glass, Check Label”). The wearable device 30 may also operate in a scanning mode, in which the image capture unit 33 repeatedly and automatically captures images, and any barcode which appears in the image is used.

Next, the wearable device 30 extracts the machine readable identification information from the captured image. Subsequently, based on the extracted identification information, the wearable device 30 queries the label information database 22 to retrieve the correct and up-to-date label information for the item.

Next, the retrieved label information is compared with the label information displayed on the human readable portion 142 of the product label 14. In one embodiment, the wearable device 30 shows the retrieved label information on the display 38. Consequently, the user can quickly compare the retrieved label information with the displayed label information, and identify any discrepancy therebetween. In embodiments where the wearable device 30 is a pair of smart glasses, the retrieved label information may be displayed in a field of view of the user, thereby allowing simultaneous viewing of the retrieved label information and the human readable portion 142 of the product label 14.

In a further embodiment, the wearable device 30 is operable to control the image capture unit 33 to capture an image of the human readable portion 142 of the product label 14, and extract the displayed label information therefrom. In one embodiment, the wearable device 30 may use Optical Character Recognition (OCR) to extract the displayed label information from the captured image of the human readable portion 142. In one example, at least one field or portion of the label information obtained by OCR is used to retrieve the label information from the label database 22, thus allowing a comparison between these two sets of information.

In one example, the wearable device 30 compares the retrieved label information as obtained from the label information database 22 with the extracted displayed label information as obtained from the image of the human readable portion 142 captured by the image capture unit 33. The result of the comparison may be shown on the display 38. Particularly, the display 38 may be configured to show an alert to the user that there is a discrepancy between the displayed label information and retrieved label information.

In an embodiment where the wearable device 30 operates in the scanning mode, the wearable device 30 may automatically alert the user of a detected non-compliance, or potential non-compliance, without specifically needing a user input command. Consequently, the wearable device 30 can automatically identify a discrepancy between the displayed label information and the retrieved label information while in the scanning mode and alert the user to that discrepancy.

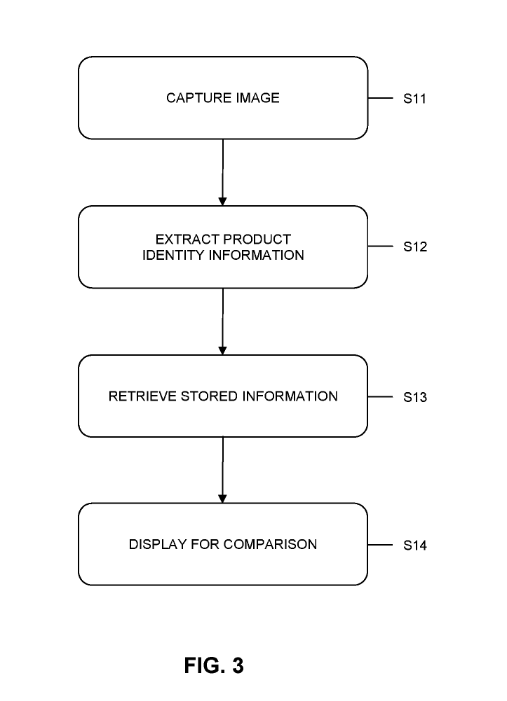

FIG. 3 is a flowchart of an exemplary method.

Step S11 comprises capturing an image of a product label 14 on a display unit 12 using a wearable device 30.

Step S12 comprises processing the captured image to extract product identity information from a machine readable portion 141 of the product label 14 in the captured image.

Step S13 comprises retrieving stored label information based on the extracted product identity information.

Step S14 comprises displaying, by the wearable device 30, the retrieved stored label information simultaneously in a field of view of the user with a human readable portion 142 of the product label 14, thereby allowing a compliance comparison therebetween

In a further exemplary embodiment, the system 200 is operable to ensure the visual compliance of a display unit 12. Particularly, the system 200 may assist in monitoring that the display unit 12 comprises the correct items, and that the items are placed in the correct position. Furthermore, the system 200 may ensure that the items are orientated correctly, and the correct quantity of items is placed thereon.

In one example, the system 200 may further comprise an image database 21, containing images of display units 12. In an exemplary embodiment, the image database 21 is located on the server 20, though it will be understood by those skilled in the art that the image database could instead be stored locally on the wearable device 30, or on any other suitable computing device.

In one example, the images in the image database 21 are reference images of ideal or planned display units 12, which are fully stocked and have all the intended items in the correct positions. Such images are also known a planograms or POGs. The planogram images may be photographs of example physical display units 12. Equally, the images may be concept diagrams or other images generated in the process of planning the configuration of the display units 12. Metadata may be associated with each display unit 12 or module, referring to the products to be stocked. The metadata may include a plurality of information fields for each product, such as: product name/description (e.g. Orange Juice); product details (Own Brand); product size (1 L); item number (e.g. retailer's stock keeping number or sku); price (£1); case quantity (number of items per pack or case, e.g. 6-pack) and fill quantity (number of cases or packs for a fully-stocked shelf, e.g. 25).

In use, the wearable device 30 may receive an input command from the user, via the input unit 37, indicating that the user wishes to check the visual compliance of a display unit 12. The input may take the form of a voice command, a button press, a touch-screen command or the like.

The wearable device 30 then determines which display unit 12 is to be checked for compliance. In an exemplary embodiment, the wearable device 30 controls the location unit 32 to establish the most proximate display unit 12, using the indoor positioning system. The location unit 32 may retrieve location data of the current display unit 12 from the server 20, or the location of relevant display units may be stored on the wearable device 30. The user then may input another command to select the display unit 12 to be checked from amongst the one or more proximate display units 12. The selected display unit 12 may have an identification number or the like associated therewith, for ease of selection and further processing.

In exemplary embodiments, the wearable device 30 may also employ measurements from accelerometers or other sensors in the device to establish the display unit 12 at which the user's attention is focused, in order to establish the display unit 12 which is to be checked for compliance.

Subsequently, the wearable device 30 retrieves the reference image of the display unit 12 to be checked, from the image database 21. In an exemplary embodiment, the wearable device 30 may query the image database 21, based on an identification number associated with the selected display unit 12, in order to retrieve the corresponding reference image.

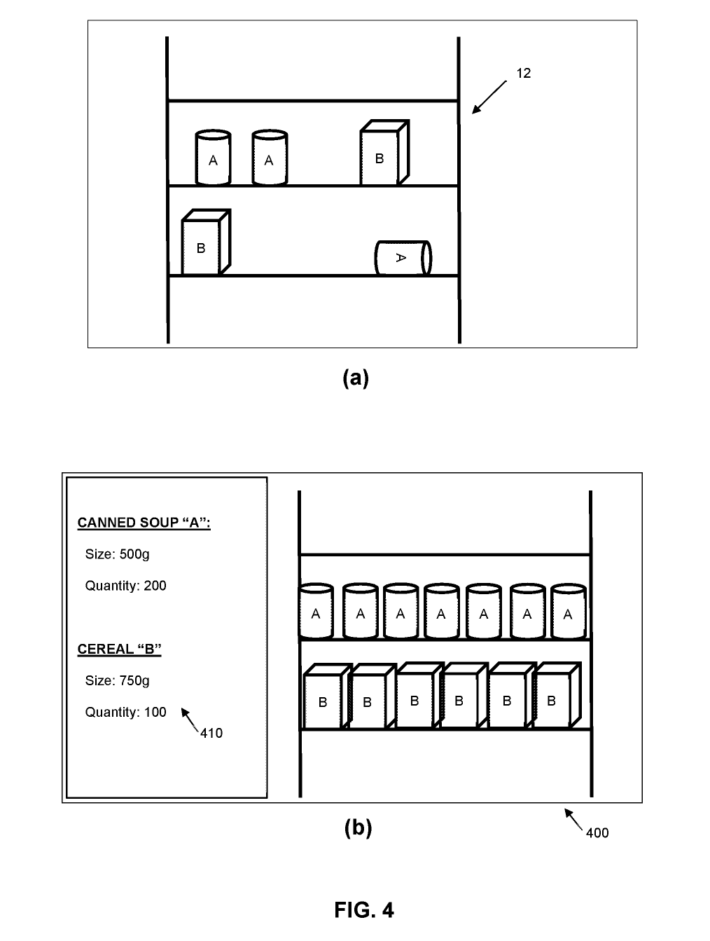

Subsequently, the retrieved reference image or planogram is displayed on the display 38. FIG. 4b shows an example reference image 400, which shows the intended state of the display unit 12. In addition to the displayed image 400, one or more lines of metadata 410 associated with the reference image 400 may also be displayed on the display 38.

Next, a comparison may be made between the retrieved reference image 400 and the actual state of the display unit 12. FIG. 4a shows an example of the actual state of the display unit 12, with FIG. 4b showing the example reference image 400 of the display unit.

In one example embodiment, the user may simultaneously view on the display 38 both the reference image 400 and the actual display unit 12. The user then may more accurately assess the state of the display unit 12. In embodiments where the wearable device 30 is a pair of smart glasses, the reference image 400 may be shown in a manner which allows the user to make the comparison easily with minimal eye movement. Particularly, the reference image 400 may be shown in the field of view of the user, allowing simultaneous viewing of the display unit 12 and the reference image 400.

The user then may return the display unit 12 to a visually compliant state, with reference to the reference image 400. This may comprise the user tidying the display unit and/or replenishing the stock held thereon.

In a further exemplary embodiment, the wearable device 30 may be configured or adapted to capture an image of the actual state of the display unit 12 using the image capture unit 33. In exemplary embodiments, the retrieved reference image 400 may be displayed on the display 38 whilst capturing the image, so that the captured image and the retrieved image may show similar vantage points, thereby easing comparison.

The wearable device 30 then compares the two images and identifies the differences therebetween. The wearable device 30 may use any suitable algorithm to identify the differences, as would be familiar to one skilled in the art.

The display 38 then shows one or both of the two images, and highlights any differences therebetween. For example, the areas of difference between the two images may be highlighted by the display. In one example, an area of interest may be marked by a coloured circle around each difference, or outlining certain portions of the display region. However, user feedback may take the form of any suitable visual or audible or tactile feedback appropriate to the configuration of the wearable device 30.

The user may then return the display unit 12 to a compliant state, with reference to the highlighted differences between the captured image and the reference image.

In a further exemplary embodiment, the wearable device 30 may be configured to enter a scanning mode while monitoring for compliance. Particularly, the wearable device 30 may monitor compliance as a background task. Monitoring may take place continuously and unobtrusively while the user carries out other duties. The user may be alerted by the device 30 when an event is detected indicating a potential non-compliance. The device 30 may then be configured to enter an investigation mode in which the situation is assessed in more detail, e.g. looking in detail at a particular display unit 12 or product label 14, and more detailed visual or other feedback provided to the user in the manner described herein.

Instead of receiving a user command to initiate the visual compliance check, the wearable device 30 may automatically retrieve the reference image 400 of the display unit 12. Particularly, the wearable device 30 may be configured to control the location unit 32 to automatically retrieve the reference image 400 of the display unit that is currently in the field of view of the user. Alternatively, the wearable device 30 may be configured to control the location unit 32 to automatically retrieve the reference image 400 of the display unit that is currently most proximate to the user.

In a further exemplary embodiment, the wearable device 30 may also be configured to automatically capture the image of the actual state of the display unit 12.

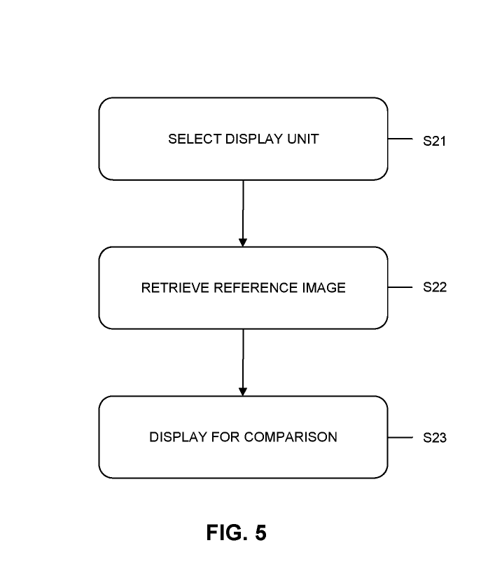

FIG. 5 is a flowchart of an exemplary method.

Step S21 comprises determining, by a wearable device, a display unit to be checked for compliance.

Step S22 comprises retrieving a reference image, the reference image showing the display unit in an ideal state.

Step S23 comprises displaying, by the wearable device, the retrieved reference image in a field of view of the user with the display unit, thereby allowing a compliance comparison therebetween.

Any of the above embodiments may be advantageously augmented by further including a second wearable device, operable to communicate with the first wearable device.

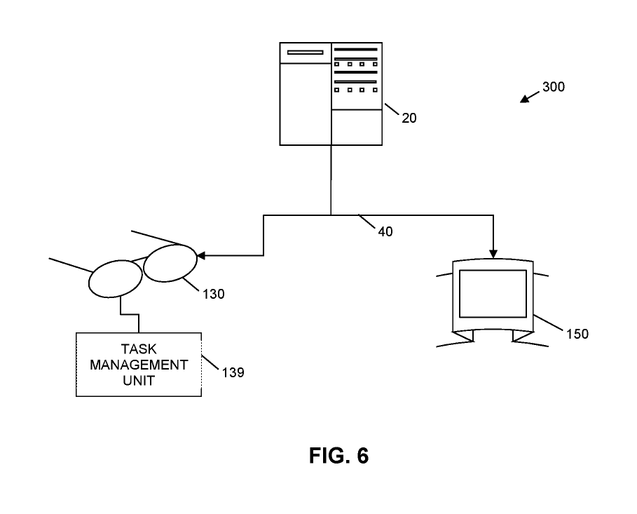

FIG. 6 shows a display unit compliance system 300 in accordance with another exemplary embodiment.

The system 300 comprises one or more servers 20 as described above, and therefore the description thereof is not repeated. In this example, the system 300 comprises at least one first portable electronic device 130 which is suitably a wearable device in the manner described above. The system 300 may further comprise at least one second portable electronic device 150, which is conveniently another wearable device.

In one example, the first wearable device 130 may be operated by a first user. In one example, the first user may be a senior member of staff who is tasked with monitoring operations in a retail store.

In one example, the first wearable device 130 further comprises a task management unit 139. The task management unit 139 is operable to create a task and to assign the task to a second user. The system 300 is then configured to transmit the task to another device which is operated by a second user. For example, the task may be “Correct non-compliant labels on display unit 4 of aisle 1” or “Replenish display unit 7 of aisle 3”. In this way, the task may be assigned to the second user. In one example, the second user is a member of staff whose regular duties include the upkeep of display units and/or the replenishment of stock.

The task management unit 139 is also operable to receive a confirmation that the task has been completed. In exemplary embodiments, the task management unit 139 may receive an image showing the now-compliant display unit 12 in order to confirm that the task has been completed.

The second wearable device 150 may be transported and operated by the second user. In one example, the device 30 may be configured as a smart watch. The smart watch is wearable around a wrist of the user while being operated. The second wearable device 150 may have a user interface (UI) unit, which shows information to the second user and receives commands and/or instructions from the second user. The user interface (UI) unit suitably comprises a display screen for displaying information to the second user, and a user input unit to receive user input commands.

The second wearable device 150 is operable to communicate with the server 20, in a similar fashion to the first wearable device 130, via an appropriate communication unit. The second wearable device 150 may therefore communicate with the first wearable device 130 via the server 20. The second wearable device 150 may also be configured to communicate directly with the first wearable device 130, without communicating via the local store server 20.

Particularly, the second wearable device 150 is operable to receive a task message originating from the first wearable device 130 and notify the user of the task such as by displaying the task on the display. The user input unit 137 may be operable to receive confirmation from the second user that the task has been completed. For example the second user may press a button or touch a region of a touch screen display to indicate that the task has been completed. The second wearable device 150 then transmits the confirmation to the first wearable device 130.

In a further exemplary embodiment the second wearable device 150 may further comprise an image capture unit. The image capture unit may include a camera within or communicably linked to the device, which is operable to capture an image of the display unit 12. The second wearable device 150 may transmit the captured image to the first wearable device 130 along with the confirmation message, in order to provide evidence that the task has been completed. These communications may occur directly, or may pass through a central command and logging station, such as provided by the server 20.

In use, the first wearable device 130 is operated as outlined in the embodiments described above. However, rather than the user of the first wearable device 130 being responsible for returning the display unit 12 to a compliant state, the first user controls the first wearable device 130 to set a task directed to the second device 150 for completion by the second user.

The first user may control the first wearable device 130. The command to set the task may take the form of a voice command, a button press, a gesture or similar.

The first wearable device 130 then transmits the task to the second wearable device 150. If the task relates to the shelf edge compliance of the display unit, the transmitted task may include a captured image of the product label 14. If the task relates to the visual compliance of the display unit, the transmitted task may include a reference image of the display unit 12, a captured image of the display unit 12 and/or an image highlighting the differences between reference and captured images.

On receipt of the task message, the task information may be displayed for the attention of the second user. The second user then may carry out the task—i.e. correct the shelf edge label, or replenish the relevant display unit 12—with reference to the task and images displayed. The second user may tidy the display unit 12 with reference to the reference image, thereby minimising errors in tidying or replenishment.

On completion of the task, the second user may control the second wearable device 150 to confirm that the task has been completed. In addition, the second user may control the second wearable device 150 so that the image capture unit captures an image of the now-compliant display unit 12 or product information label 14.

The confirmation message, optionally including the confirmation image, is then transmitted to the first wearable device 150. The task management unit 139 of the first wearable device may then mark the task as completed, and store the image as evidence that the task has been completed.

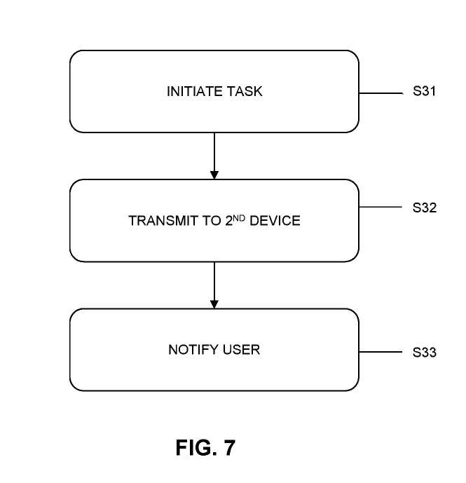

FIG. 7 is a flowchart of an exemplary method.

Step S31 comprises creating a task.

Step S32 comprises transmitting the task to a second wearable device.

Step S33 comprises displaying the task on the second wearable device.

The above-described systems and methods may advantageously allow a retail store to conveniently monitor the compliance of product labels displayed on display units. The systems and methods may help to ensure that the information displayed on product labels in the retail store is in line with the information held in a corresponding database. Consequently, errors in pricing or promotional information are avoided, thereby avoiding any customer inconvenience associated with inaccurate labelling.

The above-described systems and methods may also advantageously allow a retail store to ensure the compliance of display units, and accurately and easily assess the state of a display unit with reference to a reference image thereof.

Advantageously, the systems and methods make use of portable, wearable devices to allow the users to carry out their normal duties whilst operating the system. Retail store staff may have a wide variety of skills and backgrounds, and the above-described embodiments provide a simple and intuitive system which may be operate with minimal training.

These advantageous systems may improve the general appearance of the retail store, thereby increasing shopper convenience and sales of goods.

In a further example embodiment, certain suppliers may agree with the retailer for their products to be displayed in a certain manner or in a certain position within each store. There is then a challenge of surveying the retail stores to confirm that the products have been offered and displayed in the agreed manner. These display agreements may change frequently and may cover many different products within many different stores. Thus, there is a significant difficulty in accurately and reliably surveying products nationally across a large number of stores and for a large number of different suppliers.

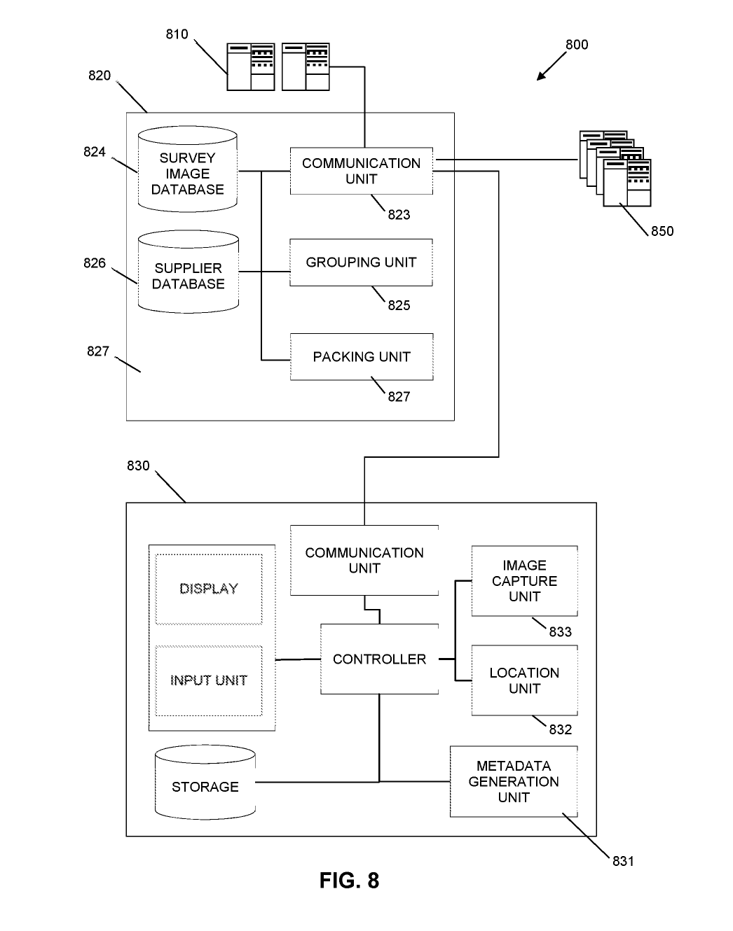

FIG. 8 shows a schematic diagram of an example display unit survey system 800.

The system 800 is operable to survey a plurality of display units 12 of the type discussed above. In particular, the system 800 may be configured to capture and collate images which provide evidence that the products have been offered and displayed in an agreed manner in a retail store 10 or within a network of retail stores.

In one example, the system 800 comprises at least one wearable device 830, and at least one server 820, which may hold a survey image database 824 and a supplier database 826.

Conveniently, the survey image database 824 stores a plurality of survey images captured by the one or more wearable devices 830. The survey image database 824 may additionally store survey image metadata associated with each of the survey images.

Meanwhile, the supplier database 826 suitably stores relevant supplier details. In one example, the supplier details may comprise information relating each display unit 12 within the retail store 10 to a particular supplier entity. In other examples, the supplier details in the database 826 may instead or additionally comprise information relating each product in the retail store 10 to a particular supplier.

In one example, the server 820 comprises a communication unit 823, a grouping unit 825 and a packaging unit 827.

The communication unit 823 may be configured in accordance with the server communication unit described above, and therefore the description is not repeated. The communication unit 823 may be configured to transmit and receive data to and from at least one recipient device 850 in a supplier system. In one example, the communication unit 823 is configured to transmit a package of survey images to a particular supplier system 850.

The communication unit 823 may be further configured to transmit and receive data to and from a controlling server 810, such as at a head office site of the retailer. In one example, the communication unit 823 is configured to transmit a package of survey images to the controlling server 810 for further collation or grouping. The controlling server 810 may then dispatch a relevant package to a recipient device 850 of the supplier entity. In one example, information for updating the supplier database 826 may be received from the controlling server 810, via the server communication unit 823.

Conveniently, the survey image database 824 and the supplier image database 826 are held, at least partially, on a local in-store server 820. However, it will be understood by those skilled in the art that the survey image database 824 and the supplier image database 826 could instead be stored elsewhere, such as remotely on one of the controlling servers 810 or locally on the wearable device 830, e.g. by caching part or all of the stored information. Further, some or all of the databases may be made available via any other suitable computing device as a distributed database which is accessed by any suitable local or remote network.

In one example, the grouping unit 825 is configured to collate the survey images stored in the survey image database 824. Particularly, the grouping unit 825 is configured to collate the survey images into one or more supplier groups, wherein each supplier group comprises survey images which show the products of one supplier entity. Conveniently, the grouping unit 825 is configured to group the survey images into the supplier groups according to the survey image metadata stored in the survey image database 824. Particularly, the grouping unit 825 is configured to determine the supplier associated with each survey image based on the survey image metadata, and then group the survey images based on the determined supplier.

In one example, the survey image metadata relates to a product shown in a survey image. In the example, the grouping unit 825 is configured to query the supplier database 826 to determine the supplier associated with the product, based on the survey image metadata.

In a further example, the survey image metadata relates to a display unit 12 on which a product is displayed. In the example, the grouping unit 825 is configured to query the supplier database 826 to determine the supplier entity associated with the display unit 12, based on the survey image metadata.

In one example, the grouping unit 825 is configured to update the survey image metadata stored in the survey image database 824 so that the updated survey image metadata includes details of the supplier associated with each respective survey image. In a further example, the grouping unit 825 may query the supplier database 826 on-the-fly to determine the supplier associated with a survey image.

In one example, the grouping unit 825 is also configured to group each supplier group into further subgroups. In one example, the further subgroups may be display unit subgroups, wherein each display unit subgroup contains survey images relating a single display unit 12 in the retail store 10. In further examples, the further subgroups may be product subgroups, wherein each product subgroup contains survey images relating to a particular product. In an example where the survey image database 824 contains survey images captured in a plurality of retail stores 10, each subgroup may contain survey images relating to a single retail store 10, or may relate to a particular product displayed within multiple stores.

The grouping unit 825 is configured to group the survey images according to any combination of the above criteria. For example, the grouping unit 825 may be configured group the images into supplier groups, then group each supplier group into a display unit subgroup, and then group each display unit subgroup into a product subgroup.

The packaging unit 827 is configured to package the grouped survey images into an appropriate format for further communication. In one example, the packaging unit 827 is configured to create a hierarchical folder structure, wherein each folder in the hierarchical folder structure relates to a particular group or subgroup.

The packaging unit 827 is further configured to store the hierarchical folder structure in an archive file. The archive file may be in a format such as .ZIP or .TAR or similar.

In one example, the packaging unit 827 is further configured to generate a survey report describing the survey images shown in the package. The survey report may be generated based on information stored in the survey image database 824 and/or the supplier database 826.

The wearable device 830 is conveniently arranged similar to the wearable devices as described above, and thus the description thereof is not repeated. In this example, the wearable device 830 comprises, inter alia, a metadata generation unit 831, a location unit 832 and an image capture unit 833.

The metadata generation unit 831 is configured to generate survey image metadata associated with each survey image captured by the wearable device 830. In one example, metadata generation unit 831 is configured to generate survey image metadata which associates each survey image with the display unit 12 shown therein. The wearable device 830 is configured to control the location unit 832 to establish the position of the device 830, and then determine the display unit 12 based on the established position. The metadata generation unit 831 is then configured to record the determined display unit 12 in the generated survey image metadata.

In further examples, the wearable device 830 additionally employs measurements from accelerometers or other sensors in the wearable device 830 to establish the display unit 12 at which the user's attention is focused, in order to generate the survey image metadata.

It will be understood that in further examples, the survey image metadata may instead comprise the established location and/or the measurements of accelerometers or other sensors. The determination of the relevant display unit 12 may then instead be carried out by the server 820.

In a further example, the survey image metadata may instead or additionally associate each survey image with a product shown therein. The wearable device 830 may control the image capture unit 833 to capture machine-readable data attached to the product. In one example, the machine-readable data is a barcode. The metadata generation unit 831 is then configured to record the machine-readable data in the generated survey image metadata.

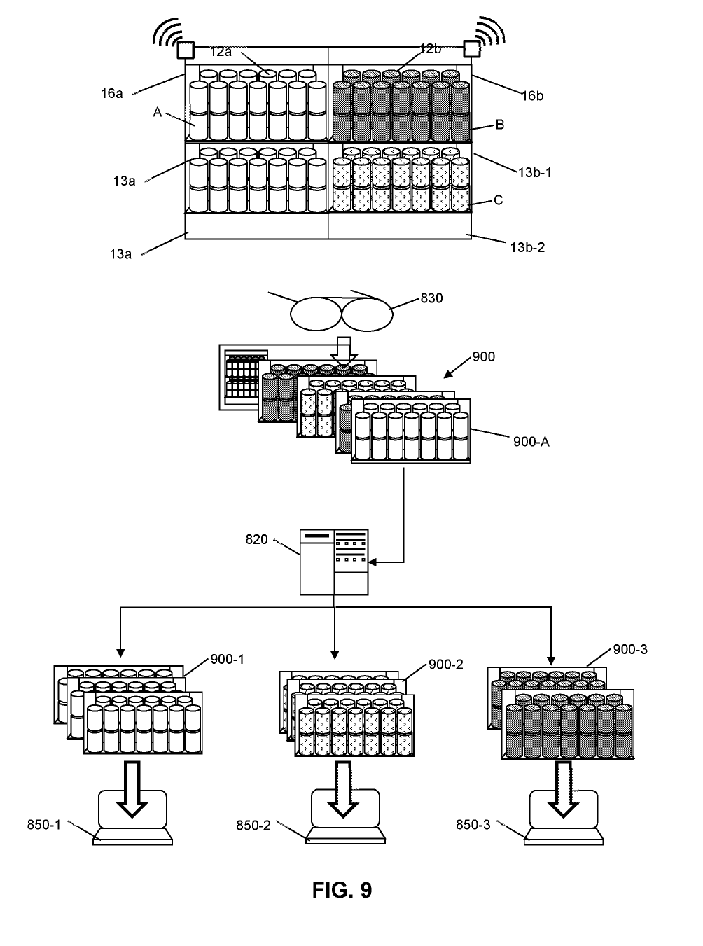

FIG. 9 is a schematic diagram illustrating the example system 800 in use.

FIG. 9 shows two exemplary display units 12a and 12b which are surveyed by the system 800. It will be understood that the description is not limited thereto, and the system 800 may, for example, survey any number of the display units 12 within a given retail store or may be used to visit several store locations.

Each display unit 12 may comprise a respective locator beacon 16a, 16b, each forming part of an indoor positioning system of the retail store 10. In one example the locator beacons 16 are provided in accordance with the description above, which is therefore not repeated.

In one example, each display unit 12 comprises a plurality of shelves 13, each configured to hold a plurality of products. Particularly, shelves 13a of display unit 12a are configured to hold a plurality of products A. Shelf 13b-1 of display unit 12b is configured to hold a plurality of products B. Shelf 13b-2 of display unit 12b is configured to hold a plurality of product C. It will be understood that this is merely an exemplary configuration of a display unit 12, and that the system 800 may survey display units 12 having a wide variety of configurations and products located thereon.

In use, the wearable device 830 controls the image capture unit 833 to capture a plurality of survey images 900 of the display units 12 and the products A, B, C displayed thereon.

The wearable device 830 may operate in a manual survey mode, in which survey images 900 are captured in response to a user command received via the input unit (e.g. a spoken command such as “Glass, survey display unit”). The wearable device 830 may also operate in a scanning survey mode, in which the image capture unit 833 repeatedly and automatically captures the images 900 while being worn by the user. Advantageously, the scanning survey mode may operate in a background mode, in which the images 900 may be taken while the user is engaged with other tasks. The user may even actively control the wearable device 830 to perform other tasks concurrently with the surveying of display units 12.

In one example, the wearable device 830 controls the metadata generation unit 831 to generate survey metadata associated with each survey image 900. In one example, the survey metadata links each image 900 to the display unit 12 shown in the survey image 900. The wearable device 830 controls the location unit 832 to establish the position of the device 830 using the indoor positioning system, and establishes the display unit 12 shown in the survey image 900 based on the position. For example, the location unit 832 may determine that the most proximate locator beacon 16 is locator beacon 16a of display unit 12a. Consequently, the wearable device 830 may determine that the display unit 12a is the most proximate display unit 12 and metadata generation unit 831 may generate survey image metadata recording the determined most proximate display unit 12a.

The wearable device 830 may also employ measurements from accelerometers or other sensors in the device 830 to establish the display unit 12 at which the user's attention is focused, in order to generate the metadata. In further examples, the location unit 832 may establish the location based on the capture of machine-readable data located on the display unit 12. The capture may take place substantially simultaneously with the image capture, or may occur at a time before, or after, the survey images 900 are captured.

In a further example, the survey image metadata links each image 900 with the products A-C shown therein. The wearable device 830 controls the image capture unit 833 to capture machine-readable data attached to the product A, B, C. The capture of the machine-readable data may take place before, or after, the images 900 are captured.

The metadata generation unit 831 may also determine that a survey image 900 does not show a display unit 12 or a product A-C. In one example, the determination may be due to the established position being not sufficiently proximate to a display unit 12. The metadata generation unit 831 may record the determination in the generated survey image metadata.

Next, the wearable device 830 controls the communication unit to transmit the captured survey images 900 and generated survey image metadata to the server 820. It will be understood by those skilled in the art that such transmissions make take place as the survey images 900 are captured, on a periodic basis, or in response to a user command received via the input unit.

Next, the server 820 stores the survey images 900 and the survey image metadata in the survey image database 824. Notably, the images and the metadata may be stored in a manner which is difficult to subvert, thus providing a high degree of trust in the stored data. For example, providing detailed metadata allows a security function to confirm that the presented data is consistent with expectations (e.g. that the timestamp is correct, that the local and global location information are matching). Such detailed metadata makes subversion or impersonation of the system very difficult. As a result, the captured information has a high degree of confidence to be trusted by each device and entity involved.

In one example, the grouping unit 825 may determine the supplier entity associated with each of the survey images 900, based on one or more fields of the associated survey image metadata. In one example, the grouping unit 825 queries the supplier database 826 in order to determine the relevant supplier entity, which may then be associated with this particular image.

FIG. 9 shows a survey image 900-A, which shows a plurality of products A. In one example, the survey image metadata associated with the survey image 900-A records that image relates to the display unit 12a. The grouping unit 825 queries the supplier database 826 to determine the supplier entity 850 associated with display unit 12a.

In a further example, the survey image metadata associated with the survey image 900-A records that the survey image relates to the product A. The grouping unit 825 queries the supplier database 826 to determine the supplier associated with product A.

Next, the grouping unit 825 collates the images 900 stored in the survey image database 824, according to the determined supplier entity. FIG. 9 shows three groups of images 900-1, 900-2, 900-3. Group 900-1 comprises survey images of products A, supplied by a first supplier. Group 900-2 comprises survey images of products B, supplied by a second supplier. Group 900-3 comprises survey images of products C, supplied by a third supplier.

The grouping unit 825 may carry out the collating periodically, for example once a day or once a week. The collating may also be initiated on demand by a user. A subset of the survey images stored in the survey image database 824 may be collated, rather than all the images. For example, survey images captured in a fixed time period, for example the last day or last week, may be collated.

In one example, the grouping unit 825 discards survey images 900 having survey image metadata which indicates that the image 900 does not show a display unit 12 or a product A-C.

In further examples, the grouping unit 825 may further collate the images 900 according to one or more of the products A-C shown therein, the display unit 12 shown therein, or the retail store 10 in which the image was captured.

Next, the packaging unit 827 generates one or more packages containing the grouped images. In one example, each package comprises a group 900-1, 900-2, 900-3, relating to a single supplier. Conveniently, each package comprises an archive file suitable for electronic transmission.

In one example, the packing unit 827 also generates a survey report. The survey report contains relevant human-readable metadata describing the contents of each package. Particularly, the survey report may contain human-readable descriptions of the products A-C shown in the survey images 900, the locations of the display units 12 shown in the survey images 900, and other pertinent information which may aid the understanding of the contents of the package. In one example, the human-readable metadata is stored in the survey image database 824 as part of the survey image metadata. In a further example, the packaging unit 827 looks up the relevant human-readable metadata in the supplier database 826, based on the survey image metadata. In one example the packing unit 827 generates the survey report using a pre-prepared document template. The survey report may comprise part of the package or may be separate therefrom.

Next, the server 820 controls the communication unit 823 to transmit the packages to a relevant recipient.

In one example, the communication unit 823 transmit the packages to a relevant supplier system 850. Particularly, as shown in FIG. 9, a package comprising survey images 900-1 showing products A supplied by the first supplier are transmitted to a system 850-1 of the first supplier. Similarly, packages comprising survey images 900-2 and 900-3 are respectively transmitted to supplier systems 850-2 and 850-3 of the second and third suppliers.

In a further example, the relevant recipient may instead be a server located in another store, a regional data processing site or a head office site.

The communication unit 823 uses any suitable means of communicating each package to the relevant recipient. In exemplary embodiments, the images may be transmitted by email or by a transfer protocol such as FTP, HTTP, SCP, SFTP or similar.

In one example, the communication unit 823 queries the supplier database 826 to retrieve relevant contact information for use in communicating the packages. For example, the communication unit 823 may retrieve an address, such as an email address. Alternatively, the communication unit 823 may retrieve a Uniform Resource Locator (URL) which relates to the supplier system 850. The communication unit 823 then transmits the packages based on the contact information.

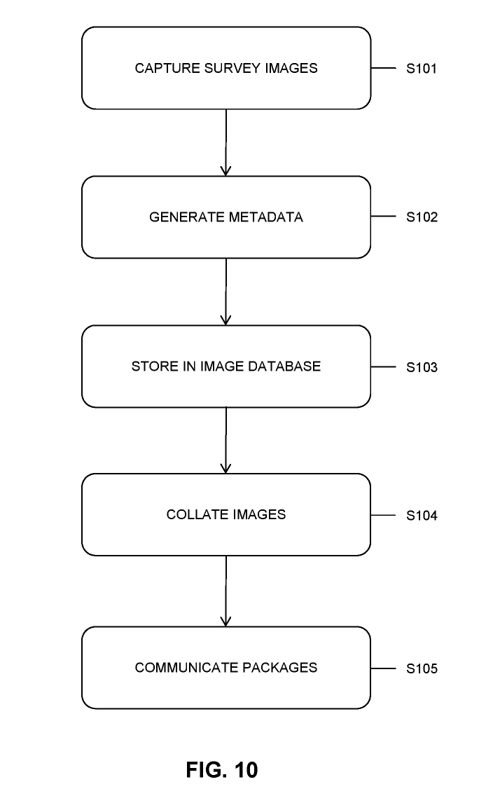

FIG. 10 is a flowchart of an exemplary method of surveying a retail store using the apparatus and system described herein.

The step S101 may include capturing a plurality of survey images showing the display units, using a portable in-store electronic device such as the wearable device 30 discussed herein. The step S102 may include generating survey image metadata associated with each said survey image, respectively. The step S103 may include storing the captured survey images and generated survey image metadata in a survey image database 824. The step S103 may include determining a supplier entity relevant to each captured survey images in the survey image database 824 based on the survey image metadata. This step may be performed by consulting a supplier database 826. The step S104 may include collating the stored survey images into a plurality of packages according to the determined supplier entity for each image. The step S105 may include communicating each package across a computer network to at least one relevant recipient device 850 of the determined supplier entity.

The above-described systems and methods may advantageously allow a retail store operator survey their stores in order to provide evidence that products supplied by third party suppliers are displayed in accordance with the requirements imposed on the retail store. Consequently, the costs, time and resources associated with documenting the display of third party supplied items may be alleviated.

Advantageously, the systems and methods make use of fine-grained metadata regarding the location and configuration of display units and products in order to automatically generate metadata associating captured images with the display units and products shown therein. Advantageously, the systems and methods provide a mechanism for automatically providing the relevant supplier with images of their products on display in the store.

Although a few preferred embodiments have been shown and described, it will be appreciated by those skilled in the art that various changes and modifications might be made without departing from the scope of the invention, as defined in the appended claims.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality.

In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Although the example embodiments have been described with reference to the components, modules and units discussed herein, such functional elements may be combined into fewer elements or separated into additional elements. Various combinations of optional features have been described herein, and it will be appreciated that described features may be combined in any suitable combination.

In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

What is claimed:

1. A system for surveying display units in a retail store, comprising:
a wearable device configured to be worn by a user while in use, wherein the wearable device is configured to capture a plurality of survey images showing display units in a retail store and to generate survey image metadata associated therewith, and
at least one server device coupled to the wearable device by a communication network, the at least one server device comprising a survey image database configured to store the survey images and the survey image metadata associated with the survey images, wherein the at least one server device is configured to determine a supplier entity for each survey image according to the survey image metadata, collate the stored survey images into a plurality of packages according to the determined supplier entity, and communicate each package to a recipient device of the determined supplier entity.

2. The system of claim 1, wherein the at least one server device holds a supplier database and is configured to determine the supplier entity for each survey image according to the survey image metadata, using the supplier database.

3. The system of claim 2, wherein the survey image metadata relates the survey image to a respective display unit and wherein the supplier database relates display units to supplier entities.

4. The system of claim 2, wherein the survey image metadata relates the survey image to a respective product on a display unit and wherein the supplier database relates product data to supplier entities.

5. The system of claim 1, wherein the at least one server device is configured to collate the survey images stored in the survey image database into one or more supplier groups, wherein each supplier group comprises survey images which show the products of one respective supplier entity.

6. The system of claim 5, wherein the at least one server device is configured to group each supplier group into one or more further subgroups including retail store location sub-groups, display unit sub-groups and/or product sub-groups.

7. The system of claim 1, wherein the at least one server device is configured to pack the collated survey images into the package for communication to a recipient device of a respective supplier entity.

8. The system of claim 7, wherein the at least one server device configured to provide a hierarchical folder structure within the package.

9. The system of claim 7, wherein the package comprises an archive file.

10. The system of claim 7, wherein the package further comprises a survey report describing the survey images provided in the package.

11. The system of claim 1, wherein the at least one server device comprises a controlling server linked by a communication network to a plurality of local servers each operating in a respective retail store location and communicatively coupled to one or more wearable devices in the respective retail store location.

12. The system of claim 11, wherein the controlling server is configured to collate a plurality of the survey images that have been captured at each of a plurality of retail store locations together into one package and to communicate the one package to the recipient device of the determined supplier entity.

13. The system of claim 1, wherein the system includes a plurality of said wearable devices which are each configured to capture the survey images and obtain the survey image metadata associated with each survey image based on a current location of each said wearable device, and wherein the at least one server device is configured to collate a plurality of the survey images received from the plurality of wearable devices together into one package for each determined supplier entity.

14. The system of claim 1, wherein the wearable device is configured to operate in a scanning mode, in which the wearable device automatically and repeatedly captures the survey images without additional user inputs.

15. The system of claim 1, wherein the wearable device is a pair of smart glasses.

16. A method of surveying display units in retail stores, the method comprising:
capturing a plurality of survey images showing the display units;
generating survey image metadata associated with each said survey image, respectively;
storing the captured survey images and generated survey image metadata in a survey image database;
determining a supplier entity relevant to each captured survey images in the survey image database based on the survey image metadata;
collating the stored survey images into a plurality of packages according to the determined supplier entity for each image, and
communicating each package across a computer network to at least one relevant recipient device of the determined supplier entity.

17. The method of claim 16, wherein the computer network comprises a controlling server linked by a communication network to a plurality of local servers each operating in a respective retail store location, and wherein the method includes:
collating a plurality of the survey images that have been captured at each of a plurality of retail store locations together into one package, and
communicating the one package to the recipient device of the determined supplier entity.

18. The system of claim 16, wherein the computer network includes a plurality of wearable devices which are each configured to capture the survey images and obtain the survey image metadata associated with each survey image based on a current location of each said wearable device, and wherein the method comprises:
collating a plurality of the survey images received from the plurality of wearable devices together into one package for each determined supplier entity, and
communicating the one package to the recipient device of the determined supplier entity.

19. A computer readable medium having instructions recorded thereon which when executed by a computer device cause the computer device to cooperate in performing a method of surveying display units in retail stores, the method comprising:
capturing a plurality of survey images showing the display units;
generating survey image metadata associated with each said survey image, respectively;
storing the captured survey images and generated survey image metadata in a survey image database;
determining a supplier entity relevant to each captured survey images in the survey image database based on the survey image metadata;
collating the stored survey images into a plurality of packages according to the determined supplier entity for each image, and
communicating each package across a computer network to at least one relevant recipient device of the determined supplier entity.
